(19) United States
(12) Patent Application Publication
(10) Pub. No.: US 2014/0190303 A1
(43) Pub. Date: Jul. 10, 2014

(54) BICYCLE CONTROL DEVICE

(71) Applicant: AD-II ENGINEERING INC., Taichung City (TW)

(72) Inventor: Hsueh-Chih MU, Taichung City (TW)

(73) Assignee: AD-II ENGINEERING INC., Taichung City (TW)

(21) Appl. No.: 13/950,321

(22) Filed: Jul. 25, 2013

(30) Foreign Application Priority Data
Jan. 10, 2013 (TW) 102100948

(51) Int. Cl. B62M 25/08

(52) U.S. Cl. CPC B62M 25/08
USPC 74/473.13

(57) ABSTRACT

A bicycle control device of the present invention includes a supporting member, a brake lever and a pivot axle mounted between the supporting member and the brake lever, and an electrical shift control unit, which includes a main body mounted in the pivot axle, and an input module electrically coupled with the main body and having a part exposed to the outside of the supporting member. The electrical shift control unit has the advantages of excellent structural stability and high durability, and enables the bicycle rider to control gear shifting of the bicycle by means of the input module.

### BACKGROUND OF THE INVENTION

1. Field of the Invention

The present invention relates to a bicycle mechanism and more particularly, to a bicycle control device for conveniently gear shifting of a derailleur, having the advantages of excellent structural stability and high durability.

2. Description of the Related Art

With the ever rising of the energy price, bicycle riding has become the most popular pastime, sports and transportation method. For the purpose of riding comfort, the ability of gear changing has become the basic and one of the most desirable functions of a bicycle.

Conventionally, the control of a derailleur of a bicycle is achieved by means of pulling a derailleur cable mechanically. In other words, a control lever is mounted adjacent to the brake lever for manual operation by the bicycle rider. With the help of the fast development of electronic control technology in recent years, some bicycle manufacturers started to install electronic switches in the brake lever for the control of the derailleur of the bicycle. U.S. Pat. No. 6,015,036, entitled “ELECTRICAL SHIFT CONTROL DEVICE FOR A BICYCLE TRANSMISSION”, discloses a bicycle control device. This design discloses the arrangement of the electrical shift control switches on the brake lever for finger operation. However, inherent in this design, the wires of the electrical shift control switches must be laid through the pivoting area of the brake lever. Thus, this design is not conducive to the wiring of the electrical shift control switches.

U.S. Pat. No. 6,073,730, entitled “BICYCLE SWITCH AND BRACKET COVER THEREFOR”, discloses another bicycle control device. According to this disclosure, the switches are mounted in a switch mounting recess of a brake member bracket which is for use in fastening the handlebar of the brake. Although such design contributes to solve the electrical wiring problem, the structural strength of the brake member bracket is sacrificed due to the switch mounting recess. Besides, such design also leads to poor ergonomics satisfaction.

U.S. Pat. No. 6,698,567 discloses yet another bicycle control device, entitled “ELECTRIC CONTROL DEVICE FOR A MOTOR-DRIVEN DERAILLEUR FOR BICYCLES”, which comprises: a supporting body provided with means for fixing it to a bicycle bracket, a brake control lever hinged to the supporting body, a pair of electric switches to control gear change carried by the supporting body, and a gear change lever that can be operated manually to control at least one of the switches. Even though such bicycle control device satisfies ergonomic criteria and solves the electrical wiring problem, complicate structure and lowered durability just become other problems thereof.

### SUMMARY OF THE INVENTION

The present invention has been accomplished under the circumstances in view. It is the main object of the present invention to provide a bicycle control device, which can be firmly mounted in the bicycle handlebar and is convenient in operation.

It is another object of the present invention to provide a bicycle control device, which has the advantages of simple structure, easy installation and high durability.

To achieve these and other objects of the present invention, a bicycle control device is provided, which includes a supporting member, a brake lever movably connected to the supporting member, a pivot axle mounted between the supporting member and the brake lever, and an electrical shift control unit. The electrical shifting control unit includes a control module mounted to the pivot axle for generating a gear shifting control signal, and an input module electrically connected to the control module. The input module has at least one protruded part exposed to the outside of the supporting member.

Thus, the pivot axle of the bicycle control device enhances the structural strength of the control module. By arranging the input module on the supporting member or at a suitable place adjacent to the brake lever, the bicycle rider can operate the input module with the hand to control gear shifting of the derailleur of the bicycle.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating an electrical shift control unit installed in the bicycle control device in accordance with the first embodiment of the present invention.

FIG. 2 is schematic perspective view of the first embodiment of the present invention, illustrating the electrical shift control unit installed in the pivot axle.

FIG. 3 is a schematic drawing illustrating an electrical shift control unit installed in the bicycle control device in accordance with the second embodiment of the present invention.

FIG. 4 is a schematic exploded view of the second embodiment of the present invention, illustrating the relationship between the electrical shift control unit and the pivot axle.

FIG. 5 is a schematic drawing illustrating an electrical shift control unit installed in the bicycle control device in accordance with the third embodiment of the present invention.

FIG. 6 is a schematic drawing, illustrating the relationship between the electrical shift control unit and the pivot axle in accordance with the third embodiment of the present invention.

FIG. 7 is a schematic drawing illustrating an electrical shift control unit installed in the bicycle control device in accordance with the fourth embodiment of the present invention.

FIG. 8 is a schematic drawing, illustrating the relationship between the electrical shift control unit and the pivot axle in accordance with the fourth embodiment of the present invention.

### DETAILED DESCRIPTION OF THE INVENTION

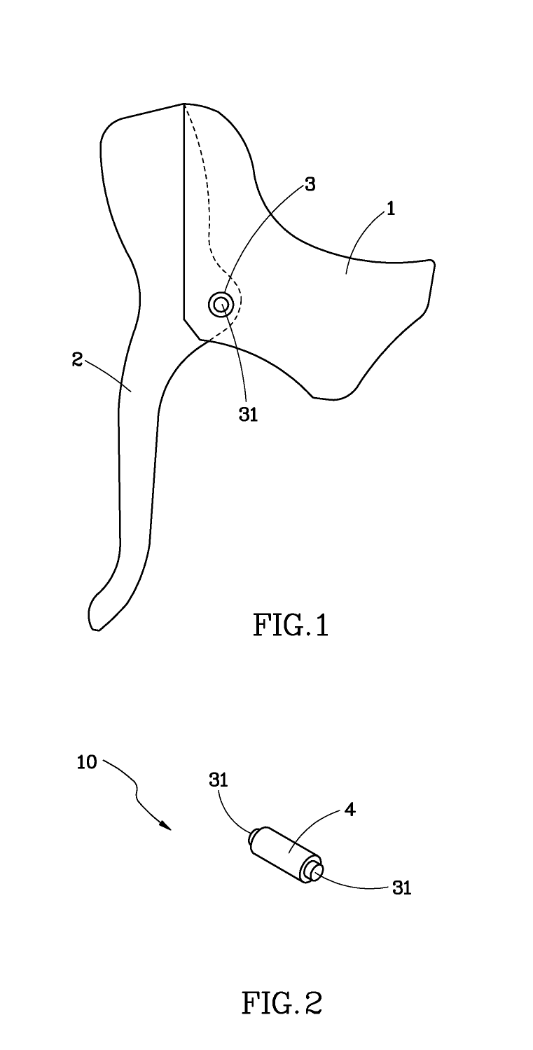

Referring to FIGS. 1 and 2, an electrical shift control unit 10 is installed in a bicycle control device in accordance with a first embodiment of the present invention. The bicycle control device further includes a supporting member 1 defining therein an axial bore 3, a brake lever 2 pivotally connected to the supporting member 1, and a pivot axle 4 mounted in the axial bore 3 of the supporting member 1 and works as the rotation axis of the brake lever 2. In this embodiment, the pivot axle 4 is a tubular member that does not rotate with the brake lever 2.

The electrical shift control unit 10 includes a control module (not shown) mounted inside the pivot axle 4 for generating and transmitting a gear shifting control signal, and an input module 30 formed of two press-buttons 31. These two press-buttons 31 are electrically connected to the control module and respectively protrusive from the opposite ends of the pivot axle 4 to extend out off the axial bore 3 to the outside of the supporting member 1. Thus, the bicycle rider can press the press-buttons 31 with fingers for gear shifting control.

Furthermore, rotary buttons can be used in substitution of the aforesaid press-buttons, enabling bikers to make a gear shifting control by rotating the rotary buttons with the fingers.

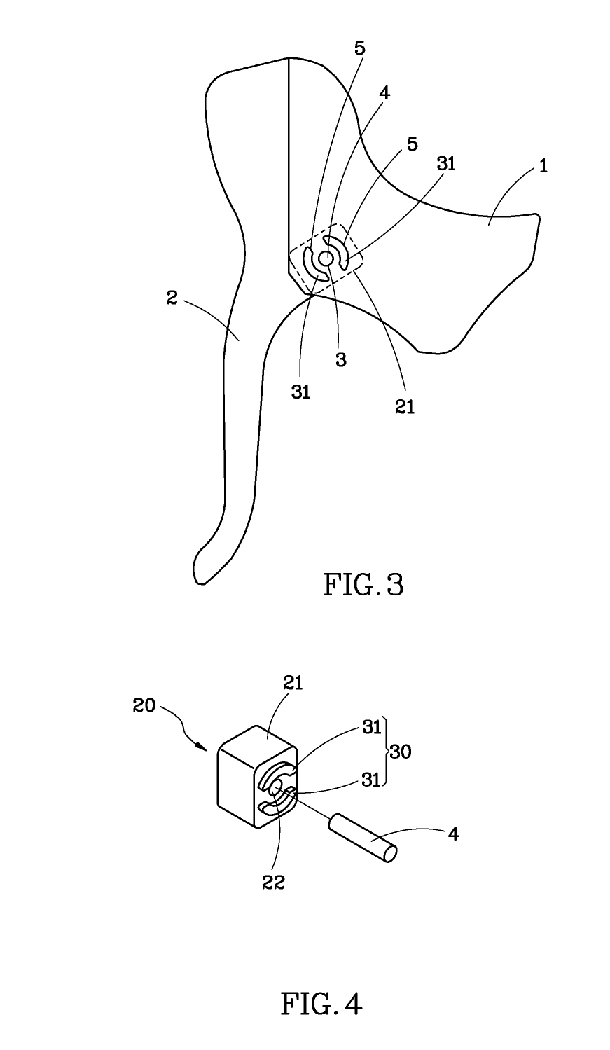

In the aforesaid embodiment of the present invention, the press-buttons 31 are arranged at two opposite sides of the supporting member 1. To enable the bicycle rider to control the gear shifting with one single finger, the supporting member 1 in accordance with the second embodiment of the present invention, as shown in FIGS. 3 and 4, is configured to provide two button slots 5 spaced around the axial bore 3, and the pivot axle 4 is made in the form of a solid cylinder fixedly mounted in the axial bore 3.

In this second embodiment, the control module 20 of the electrical shift control unit 10 includes a housing 21 fixedly mounted inside the supporting member 1 and defining a through hole 22 for the insertion of the pivot axle 4; the press-buttons 31 of the input module 30 are mounted at one side of the housing 21 and extended out off the button slots 5 respectively to the outside of the supporting member 1, allowing the bicycle rider to operate the press-buttons 31 with one single finger.

In the aforesaid embodiments, the control module is mounted to the pivot axle inside the supporting member, such that the space occupation is reduced and the structural strength is maintained. Further, the input module is mounted at the supporting member, and therefore the bicycle rider can operate the input module with the fingers grasping the supporting member. As a result, the control module outputs a gear shifting control signal to shift the derailleur.

Although the input module of the aforesaid embodiments is mounted at the supporting member, it is to be noted that the input module can also be disposed adjacent to the brake lever.

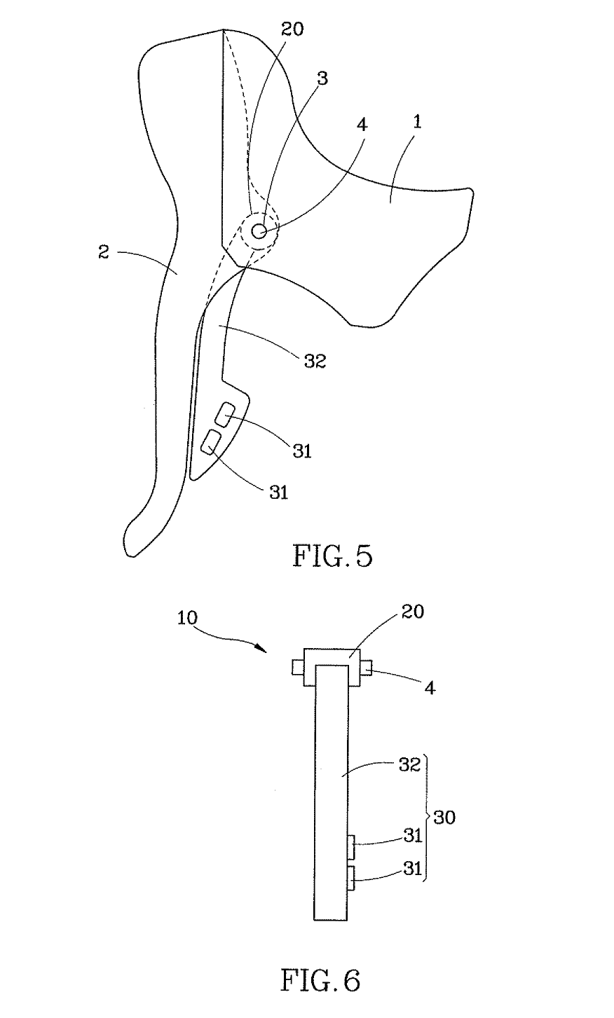

Please refer to FIGS. 5 and 6 for an electrical shift control unit 10 in accordance with a third embodiment of the present invention. The housing 21 of the control module 20 is pivotally connected to the pivot axle 4 and drivable by the brake lever 2 to move relative to the supporting member 1. The input module 30 includes an operating lever 32 extending out off the supporting member 1 along one side of the brake lever 2 and rotatable about the pivot axle 4. The press-buttons 31 are mounted on a surface of the operating lever 32.

Based on such design, the operating lever 32 can be moved with the brake lever 2 pressed by the bicycle rider. To shift the derailleur gears, the bicycle rider can operate the buttons, i.e. the electronic switches, at the operating lever 32. Such arrangement of the buttons renders optimal operating convenience.

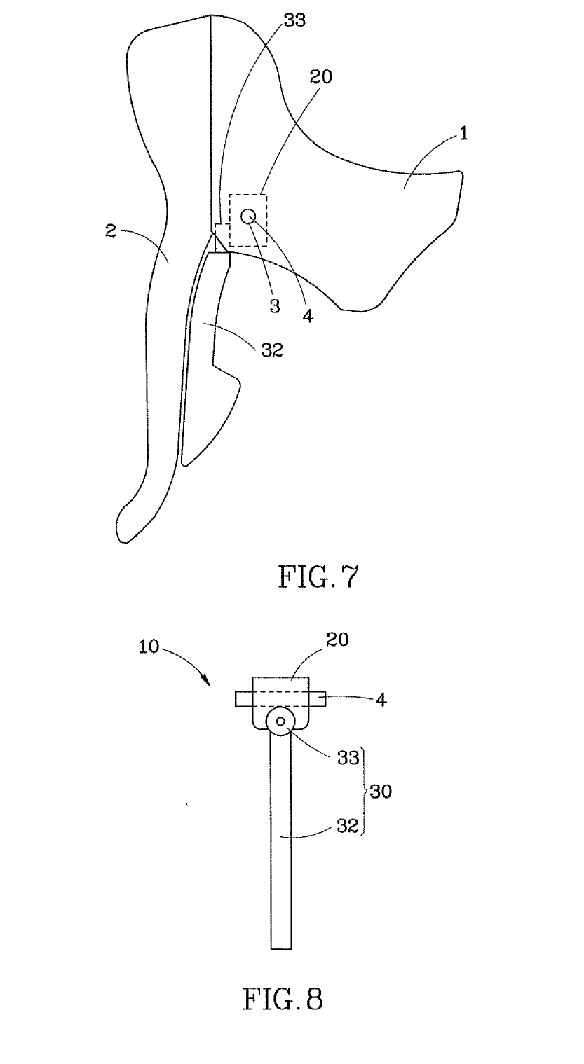

For the purpose of simplification of structure, an electrical shift control unit 10 in accordance with a fourth embodiment of the present invention, as shown in FIGS. 7 and 8, is provided. The fourth embodiment is similar to the third embodiment and yet different in ways that the input module 30 of the fourth embodiment includes a rotary button 33, rather than press-buttons, rotatably mounted to the housing 21; the operating lever 32 is connected to the rotary button 33 and rotatable relative to the housing 21 of the control module 20; and the rotating axis of the operating lever 32 is substantially perpendicular to that of the pivot axle 4. Thus, the bicycle rider can press the operating lever 32 with the fingers, driving the control module 20 to output a gear shifting control signal. Such operation manner is more ergonomic. Further, the structure of the fourth embodiment is rather simple.

In conclusion, the control module of the present invention is directly mounted to a pivot axle. Such design occupies smaller space without sacrificing the structural strength thereof. Further, the present invention also enables a variety of arrangements of the input module and therefore renders better design flexibility for installation in any of a variety of bicycle control devices while conforming with ergonomics at the same time.

Although particular embodiments of the invention have been described in detail for purposes of illustration, various modifications and enhancements may be made without departing from the spirit and scope of the invention. Accordingly, the invention is not to be limited except as by the appended claims.

1. A bicycle control device, comprising:
a supporting member;
a brake lever movably connected to the supporting member;
a pivot axle mounted between the supporting member and the brake lever; and
an electrical shift control unit, wherein the electrical shift control unit comprises:
a main body mounted to the pivot axle; and
an input module connected to the main body, the input module having at least one protruded part exposed to the outside of the supporting member.

2. The bicycle control device as claimed in claim 1, wherein the pivot axle is a tubular member; the main body is embedded in the pivot axle; the at least one protruded part of the input module is protrusive from at least one end of the pivot axle.

3. The bicycle control device as claimed in claim 1, wherein the main body is fixedly mounted inside the supporting member, the main body defines at least one through hole for insertion of the pivot axle.

4. The bicycle control device as claimed in claim 1, wherein the input module comprises at least one press-button.

5. The bicycle control device as claimed in claim 4, wherein the input module comprises two press-buttons.

6. The bicycle control device as claimed claim 1, wherein the input module comprises a rotary button.

7. The bicycle control device as claimed in claim 1, wherein the main body is pivotally connected to the pivot axle and is drivable by the brake lever to move relative to the supporting member; the input module comprises an operating lever extending from the main body along one side of the brake lever.

8. The bicycle control device as claimed in claim 7, wherein the input module comprises at least one press-button mounted on the operating lever.

9. The bicycle control device as claimed in claim 7, wherein the main body comprises a housing, the input module comprises a rotary button rotatably mounted to the housing; the operating lever is connected to the rotary button and rotatable relative to the housing.
